(19) United States
(12) Patent Application Publication
(10) Pub. No.: US 2007/0017441 A1
(43) Pub. Date: Jan. 25, 2007

(54) Standing ultrasonic wave spraying arrangement

(75) Inventors: Gert Stauch, Wiesloch/Baiertal (DE); Bjoern Matthias, Bad Schoenborn (DE); Uwe Goerges, Bochum (DE); Gunter Boerner, Sinsheim/Eschelbach (DE); Josef Wittmann, Hockenheim (DE)

Correspondence Address: BUCHANAN, INGERSOLL & ROONEY PC, POST OFFICE BOX 1404, ALEXANDRIA, VA, 22313-1404, US

(73) Assignee: ABB Patent GMBH, Ladenburg (DE)

(21) Appl. No.: 10/557,474

(22) PCT Filed: May 29, 2004
(86) PCT No.: PCT/EP04/05865

§ 371 Date: Jul. 7, 2006

(30) Foreign Application Priority Data
Jun. 18, 2003 (DE) 103 27 431.6

(51) Int. Cl. B05B 17/06; B05C 5/00; B05B 5/025

(52) U.S. Cl. 118/620; 118/300

(57) ABSTRACT

The invention relates to an ultrasonic standing-wave atomizer arrangement for producing a paint spray mist for painting a workpiece, with at least one sonotrode, with a component arranged lying opposite the at least one sonotrode, a standing ultrasonic field being formed in the intermediate space between the at least one sonotrode and the component in the case of operation, and also with at least one nozzle-shaped paint feeding device, which arranged perpendicularly in relation to the center axis of each sonotrode and introduces the paint into the intermediate space for the atomizing process at at least one paint discharge point, the component arranged lying opposite the at least one sonotrode being a coaxially aligned reflector.

The invention relates to an ultrasonic standing-wave atomizer arrangement for producing a paint spray mist for painting a workpiece, with at least one sonotrode, with a component arranged lying opposite the at least one sonotrode, a standing ultrasonic field being formed in the intermediate space between the sonotrode and the component in the case of operation. In addition, the ultrasonic standing-wave atomizer arrangement is provided with at least one nozzle-shaped paint feeding device, which is arranged perpendicularly in relation to the center axis of each sonotrode and introduces the paint into the intermediate space for the atomizing process at at least one paint discharge point.

So far, coats of paint have been applied to the bodies of automobiles and similar articles of a large area in a known way by means of high-speed rotary atomizers, which produce a fine paint spray mist which is usually applied to the surface to be coated by suitable additional measures, for example in the case of electrically conductive paints by means of an electric field.

When using an environmentally friendly water-soluble base coat in such cases, coating rates of 200 ml/mm-400 ml/mm and above are achieved. The quality required for the coating, such as evenness of the surface and avoidance of bubbles, is achieved in particular by the diameters of the paint drops of the spray mist lying in the range of 10 μm.<d_{drop}<60 μm.

The known high-speed rotary atomization has the following disadvantages, which can have an effect both on the product quality and on the required production expenditure. The atomization quality and the delivery are substantially determined by the form and rotational speed of the rotating bell, as the rotary part delivering the paint is referred to. Cleaned compressed air, which impinges on an air turbine coupled to the bell, is required for driving the bell. The cleaning of the compressed air causes additional expenditure.

As a result of the very high rotational speed of the rotary atomizers, at about 100,000 rpm, the paint particles accelerated in this way have a high initial velocity, which makes their exact alignment with the areas to be coated, for example the surface of a vehicle body, more difficult, with the result that an appreciable amount of paint flies past the target area.

In addition, the amount of paint which can be delivered per unit of time when coating by means of high-speed rotary atomizers is limited, which in turn increases the amount of time required for applying the paint.

DE 102 45 324 and DE 102 45 326 disclose an ultrasonic standing-wave atomizer arrangement of the type mentioned at the beginning in which standing-wave atomization by means of ultrasound is used instead of high-speed rotary atomization.

This involves replacing the rotating bell with a linearly vibrating ultrasonic sonotrode. This leads to an increase in the reliability or the service life of the atomizer. Moreover, there is no longer any need for the driving air for the compressed air turbine, which is expensive because of the cleaning required. Since the paint droplets have a lower initial velocity in the case of ultrasonic standing-wave atomization than in the case of high-speed rotary atomization, much less cleaned air is required to direct the paint spray mist onto the vehicle body. In addition, the losses are also less, since here less paint flies past the surface being painted.

In the case of ultrasonic standing-wave atomization, the paint has no direct contact with the atomization device. This avoids any wear because there is no abrasion. Furthermore, in the case of ultrasonic standing-wave atomization, the paint is usually applied with a spray cone of oval cross section, which can be advantageous when painting narrow parts.

On the basis of this prior art, the object of the invention is to provide an arrangement for ultrasonic standing-wave atomization of the type mentioned at the beginning which, while having a simple configuration, offers the possibility of increasing the amount that can be delivered for coating, that is the rate of paint that can be atomized.

The features of claim 1 serve according to the invention for achieving this object. Accordingly, it is provided that the component arranged lying opposite the at least one sonotrode is a coaxially aligned reflector which throws back the impinging sound waves, so as to produce a standing wave field which acts on the sheets of paint introduced into it by means of the paint feeding device and finely disperses them thereby, the paint spray mist produced in this way being accelerated onto the paint application surface by means of supplied compressed air, which does not have to be specially cleaned.

According to a preferred development, the reflector may be formed as a passive reflector, it then preferably being formed as a circular disk-shaped plate, the cross section of which is adapted to that of the assigned sonotrode.

In a further improvement of the ultrasonic standing-wave atomizer arrangement according to the invention, the thickness of the reflector corresponds to a multiple of half the wavelength of the sonic vibrations produced in the sonotrode, a favorable thickness of the plate provided as the reflector being at least 10 mm.

According to an alternatively provided solution, instead of a passive reflector, the reflector may be formed by a second sonotrode, which, in the same way as the first sonotrode already originally provided, likewise produces ultrasonic vibrations. For the purpose of producing the desired standing wave field, the second sonotrode is structurally identical to the first sonotrode, that is to say also identical in frequency, so that the sound waves emanating from the two sound generators are at most phase-shifted. The distance between the ends of the sonotrodes provided in such a way is in this case dimensioned such that the intermediate space is large enough to allow the paint feeding device to be introduced.

In the case of such an arrangement with two sonotrodes, the distance between the ends is preferably chosen such that an ultrasonic standing wave field with 5 sound particle velocity antinodes is obtained.

Instead of this, however, a distance between the ends of the sonotrodes arranged opposite one another that is at least twice as great may also be provided, 10 sound particle velocity antinodes then being obtained in each case. The overall length of such an arrangement is approximately 400 mm, the length of the usable sound field being approximately one third of the overall length.

An alternative embodiment consists in that a passive reflector aligned coaxially in relation to the sonotrodes is arranged centrally in the intermediate space between the sonotrodes arranged opposite one another. Here, too, it proves to be advantageous if the passive reflector is formed by a circular disk-shaped plate, the cross section of which is adapted to those of the two sonotrodes.

A development of the ultrasonic standing-wave atomizer arrangement according to the invention is characterized in particular in that two sub-arrangements respectively formed by a sonotrode with a passive reflector arranged lying coaxially opposite are provided. On the one hand, it is possible in this way for each of the two sub-systems, that is to say each of the two sub-arrangements, optionally to be operated at a different frequency, in these cases the sonotrodes for example being different.

One particular configuration of the invention provides that, in the case of the so-called double arrangement of two sub-systems, the centrally arranged passive reflector is virtually divided, the two individual reflectors being jointedly connected to one another by means of a hinge.

With this configuration, it is substantially ensured that the structural dimensions of such an arrangement are more or less constant, since the sound fields formed by the intermediate spaces between the sonotrodes and the assigned reflectors cannot drift arbitrarily in the axial direction.

The jointed connection mentioned helps to create the possibility of pivoting the virtually two-part ultrasonic standing-wave atomizer arrangement with respect to itself in such a way that the two spray cones produced in each of the sub-arrangements formed by a sonotrode with an assigned passive reflector can be superposed on one another in the desired way.

Accordingly, it is similarly provided that the nozzle-shaped paint feeding devices with the assigned sub-system that are located in the intermediate spaces between the sonotrode and the assigned passive reflector of each sub-arrangement are likewise pivotably arranged.

A further alternative of the variants of the ultrasonic standing-wave atomizer arrangement according to the invention that have so far been presented is characterized in that the sonotrodes of each sub-arrangement in each case have a different frequency. This advantageously allows the production and mixing of two different drop size spectra.

In a way corresponding to the basic arrangements for ultrasonic standing-wave atomization that were already referred to at the beginning, the embodiments described here are in each case provided with an air supply device, which if need be interacts with at least one air distribution device, whereby the application of paint to the target-area is achieved.

These and further advantageous configurations and embodiments are the subject of the subclaims.

The invention, advantageous configurations and improvements of the invention and its particular advantages are to be explained and described in more detail on the basis of an exemplary embodiment that is represented in the accompanying drawing, in which:

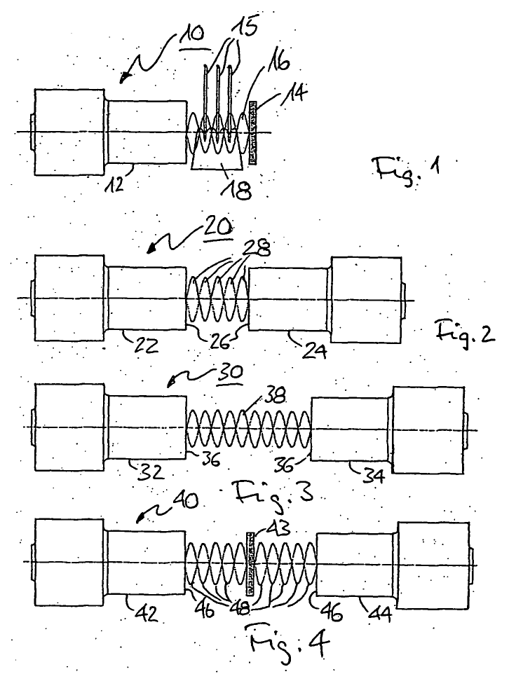

FIG. 1 shows a schematic side view of a paint spraying arrangement, with a sonotrode with a passive reflector;

FIG. 2 shows a schematic side view of a paint spraying arrangement, with a first sonotrode and a second sonotrode;

FIG. 3 shows a schematic side view of a paint spraying arrangement, with a first sonotrode and a second sonotrode, corresponding to FIG. 2, but with a greater distance from one another;

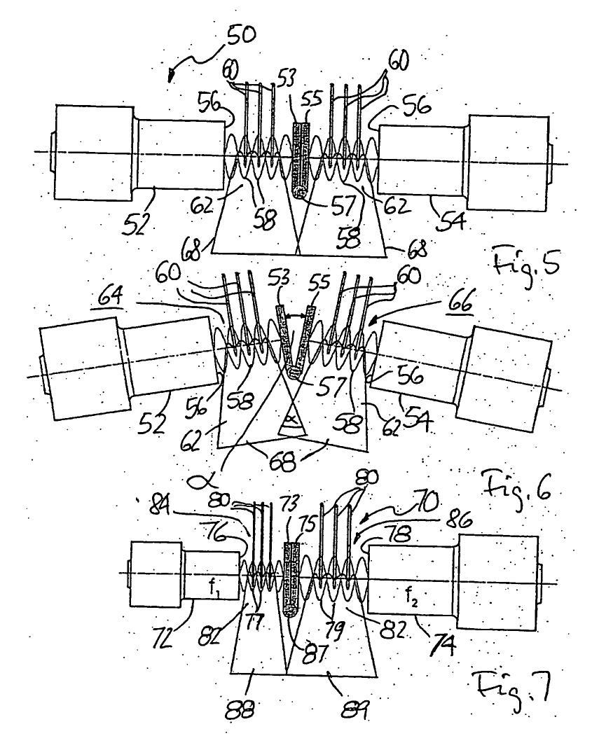

FIG. 4 shows a schematic side view of a paint spraying arrangement, with a first sonotrode and a second sonotrode, corresponding to FIG. 3, but with a passive reflector inserted centrally in between;

FIG. 5 shows a schematic side view of a paint spraying arrangement, with a first sonotrode and a second sonotrode and also with two passive reflectors inserted centrally in between, similar to FIG. 4, the reflectors being coupled to one another by a hinge;

FIG. 6 shows a schematic side view of a paint spraying arrangement, with a first sonotrode and a second sonotrode and also with two passive reflectors inserted centrally in between, corresponding to FIG. 5, although the center axes of the two sonotrodes with the assigned reflectors have an angle of 0°<α<90° in relation to one another;

FIG. 7 shows a schematic side view of a paint spraying arrangement, with a first sonotrode and a second sonotrode and also with two passive reflectors inserted centrally in between, similar to FIG. 5, the sonotrodes being provided with different cross sections and having different ultrasound frequencies.

Represented in FIG. 1 is a schematic side view of a first paint spraying arrangement 10, with a sonotrode 12 with a passive reflector 14, the axial distance between the ends of which is fixed in such a way that five sound particle velocity antinodes 16 are formed between the sonotrode 12 and the reflector 14.

Introduced into these sound particle velocity antinodes 14 are three small tubes 15 for -feeding paint, which are aligned parallel to one another and, in conjunction with the sound field formed between the sonotrode 12 and the reflector 14, in each case form a spray cone 18 widening in the spraying direction and overlapping with one another because of the small lateral spacing of the tubes 15.

Shown in FIG. 2 is a schematic side view of a second paint spraying arrangement 20, with a first sonotrode 22 and a second sonotrode 24, which are structurally identical and aligned coaxially in relation to one another. The axial distance between their end faces 26, from which the sound emanates, is in this case fixed such that five sound particle velocity antinodes 28 are formed between the first sonotrode 22 and the second sonotrode 24.

FIG. 3 shows a schematic side view of a third paint spraying arrangement 30, with a first sonotrode 32 and a second sonotrode 34, which to the greatest extent corresponds to the arrangement shown in FIG. 2, although the two sonotrodes 32, 34 are aligned coaxially in relation to one another with a greater distance between their end faces 36, so that 10 sound particle velocity antinodes 38 are formed between their end faces 36.

Shown in FIG. 4 is a schematic side view of a fourth paint spraying arrangement 40, with a first sonotrode 42 and a second sonotrode 44, which are aligned coaxially in relation to one another in a way corresponding to the arrangement shown in FIG. 3, their end faces 46, from which the sound emanates, facing toward one another. Inserted centrally between their end faces 46, that is to say between the first sonotrode 42 and the second sonotrode 44, is a passive reflector 43, the distance of the end faces 46 of the two sonotrodes 42, 44 respectively from the reflector 43 being fixed such that in each case five sound particle velocity antinodes 48 are formed.

FIG. 5 shows a schematic side view of a fifth paint spraying arrangement 50, with a first sonotrode 52 and a second sonotrode 54 and also with two passive reflectors 53, 55 inserted centrally in between, similar to the arrangement shown in FIG. 4, although in the that arrangement the reflectors 53, 55 are coupled to one another by a hinge 57.

Here, too, the distance of the end faces 56 of the two sonotrodes 52, 54 from the reflectors 53, 55 is fixed such that in each case five sound particle velocity antinodes 58 are formed. In a way similar to that already explained in relation to FIG. 1, here there are also introduced into these sound particle velocity antinodes 58 three small tubes 60 for feeding paint, which are aligned parallel to one another and, in conjunction with the sound field formed between the first sonotrode 52 and the first reflector 53 and also the sound field formed between the second sonotrode 52 and the second reflector 55, in each case form a spray cone 62 widening in the spraying direction and overlapping with one another because of the small lateral spacing of the tubes 60. On account of the small distance between the two neighboring spraying systems 64, 66 formed in this way, the spray cones 68 of the two spraying systems 64, 66 form a tangent at a specific spraying distance, so that the delivery of paint with respect to the application surface can be virtually doubled without sacrificing any coating quality.

A further special feature of this fifth arrangement is represented in more detail in FIG. 6. Shown in FIG. 6 is a schematic side view of the paint spraying arrangement according to, with the first sonotrode 52 and the second sonotrode 54 and also with the passive reflectors 53, 55 inserted centrally in between, corresponding to FIG. 5, although, as a departure from the arrangement shown in FIG. 5, the center axes of the two sonotrodes 52, 54 with the respectively assigned reflector 53, 55 are angled away in relation to one another and have an angle of >0α<90 in relation to one another.

This achieves the effect that the overlapping of the two spraying systems 64, 66 or their spray cones 68 can be adapted to local conditions.

FIG. 7 shows a schematic side view of a further paint spraying arrangement 70, with a first sonotrode 72 and a second sonotrode 74 and also with passive reflectors 73, 75 inserted centrally in between, similar to FIG. 5, the two sonotrodes 72, 74 in each case having different ultrasound frequencies f₁, f₂. Accordingly, the cross sections of the two sonotrodes 72, 74, that is to say also their end faces 76, 78, are in each case different. Here, too, the distance of the end faces 76, 78 of the two sonotrodes 72, 74 from the reflectors 73, 75 is fixed such that in each case five sound particle velocity antinodes 77, 79 are formed.

In a way similar to that already explained in relation to FIG. 1 and FIG. 5, here there are also introduced into the sound particle velocity antinodes 79 in each case three small tubes 80 for feeding paint, which are aligned parallel to one another and, in conjunction with the sound field formed between the first sonotrode 72 and the first reflector 73 and also the sound field formed between the second sonotrode 72 and the second reflector 75, in each case form a spray cone 82 widening in the spraying direction and overlapping with one another because of the small lateral spacing of the tubes 80. On account of the small distance between the two neighboring spraying systems 84, 86 formed in this way, the spray cones 88, 89 of the two spraying systems 84, 86 form a tangent at a specific spraying distance, so that here, too, the delivery of paint with respect to the application surface can be virtually doubled without sacrificing any coating quality.

List of designations

10 first arrangement
12 sonotrode
14 reflector
15 small tube
16 sound particle velocity antinode
18 spray cone
20 second arrangement
22 first sonotrode
24 second sonotrode
26 end face
28 sound particle velocity antinode
30 third arrangement
32 first sonotrode
34 second sonotrode
36 end face
38 sound particle velocity antinode
40 fourth arrangement
42 first sonotrode
43 reflector
44 second sonotrode
46 end face
48 sound particle velocity antinode
50 fifth arrangement
52 first sonotrode
53 first reflector
54 second sonotrode
55 second reflector
56 end face
58 sound particle velocity antinode
60 small tube
62 spray cone
64 first spraying system
66 second spraying system
68 spray cone
70 seventh arrangement
72 first sonotrode
73 first reflector
74 second sonotrode
75 second reflector
76 end face
77 sound particle velocity antinode
78 end face
79 sound particle velocity antinode
80 small tube
82 spray cone
84 first spraying system
86 second spraying system
88 spray cone
89 spray cone

1. An ultrasonic standing-wave atomizer arrangement for producing a paint spray mist for painting a workpiece, with at least one sonotrode, with a component arranged lying opposite the at least one sonotrode, a standing ultrasonic field being formed in the intermediate space between the at least one sonotrode and the component in the case of operation, and also with at least one nozzle-shaped paint feeding device, which is arranged perpendicularly in relation to the center axis of each sonotrode and introduces the paint into the intermediate space for the atomizing process at at least one paint discharge point, wherein the component arranged lying opposite at least one sonotrode is a coaxially aligned reflector.

2. The ultrasonic standing-wave atomizer arrangement as claimed in claim 1, wherein the reflector is formed as a passive reflector.

3. The ultrasonic standing-wave atomizer arrangement as claimed in claim 2, wherein the reflector is formed as a circular disk-shaped plate, the cross section of which is adapted to that of the sonotrode.

4. The ultrasonic standing-wave atomizer arrangement as claimed in claim 3, wherein the thickness of the reflector corresponds to a multiple of half the wavelength of the sonic vibrations produced in the sonotrode.

5. The ultrasonic standing-wave atomizer arrangement as claimed in claim 3, wherein the thickness of the reflector is at least 10 mm.

6. The ultrasonic standing-wave atomizer arrangement as claimed in claim 1, wherein the reflector is formed by a second sonotrode.

7. The ultrasonic standing-wave atomizer arrangement as claimed in claim 5, wherein the second sonotrode is structurally identical to the first sonotrode.

8. The ultrasonic standing-wave atomizer arrangement as claimed in claim 6 wherein the distance between the ends of the sonotrodes arranged opposite one another is at least twice as great as the distance between the ends in the case of an arrangement with one sonotrode and one passive reflector.

9. The ultrasonic standing-wave atomizer arrangement as claimed in claim 8, wherein a passive reflector aligned coaxially in relation to the sonotrodes is arranged centrally in the intermediate space between the sonotrodes arranged opposite one another.

10. The ultrasonic standing-wave atomizer arrangement as claimed in claim 9, wherein the passive reflector is formed by a circular disk-shaped plate, the cross section of which is adapted to those of the two sonotrodes.

11. The ultrasonic standing-wave atomizer arrangement as claimed in claim 1, wherein each sonotrode is assigned a passive reflector arranged lying coaxially opposite.

12. The ultrasonic standing-wave atomizer arrangement as claimed in claim 11, wherein the assigned passive reflectors are jointly connected to one another by means of a hinge.

13. The ultrasonic standing-wave atomizer arrangement as claimed in claim 12, wherein the two spraying systems respectively formed by a sonotrode with an assigned passive reflector are pivoted in relation to one another at an angle of 0°>α<90°.

14. The ultrasonic standing-wave atomizer arrangement as claimed in claim 13, wherein the nozzle-shaped paint feeding devices located in the intermediate spaces between the sonotrode and the assigned passive reflector of each spraying system are pivoted in relation to one another in a way corresponding to the spraying systems.

15. The ultrasonic standing-wave atomizer arrangement as claimed in claim 14, wherein the paint spray cones of the two spraying systems that are produced by the paint feeding devices overlap one another.

16. The ultrasonic standing-wave atomizer arrangement as claimed in claim 9, wherein the sonotrodes of each spraying system in each case have a different ultrasound frequency f₁, f₂.

17. The ultrasonic standing-wave atomizer arrangement as claimed in claim 16, wherein, in interaction with the paint feeding devices the sonotrodes respectively with a different ultrasound frequency f₁, f₂ produce paint drops of different sizes, which mix with one another in the overlapping spray cones.

18. The ultrasonic standing-wave atomizer arrangement as claimed in claim 4, wherein the thickness of the reflector is at least 10 mm.

19. The ultrasonic standing-wave atomizer arrangement as claimed in claim 7 wherein the distance between the ends of the sonotrodes arranged opposite one another is at least twice as great as the distance between the ends in the case of an arrangement with one sonotrode and one passive reflector.

20. The ultrasonic standing-wave atomizer arrangement as claimed in claim 11, wherein the sonotrodes of each spraying system in each case have a different ultrasound frequency f₁, f₂.
